(19) United States
(12) Patent Application Publication
(10) Pub. No.: US 2013/0180170 A1
(43) Pub. Date: Jul. 18, 2013

(54) FOOD PLOT SCREEN AND RELATED METHOD

(71) Applicant: Frigid Forage, Onamia, MN (US)

(72) Inventor: John BARSODY, Onamia, MN (US)

(73) Assignee: FRIGID FORAGE, Onamia, MN (US)

(21) Appl. No.: 13/725,418

(22) Filed: Dec. 21, 2012

Related U.S. Application Data
(60) Provisional application No. 61/579,051, filed on Dec. 22, 2011.

(51) Int. Cl. A01G 1/00

(52) U.S. Cl. CPC A01G 1/001
USPC 47/58.1 SE; 800/298; 800/320; 800/322; 800/320.3

(57) ABSTRACT

Embodiments of the present invention describe a food plot screen seed mixture including one or more low height plant seeds, one or more medium height plant seeds and one or more tall height plant seeds.

### CROSS REFERENCE TO RELATED APPLICATIONS

This application claims benefit of Application No. 61/579,051, filed on 22 Dec. 2011 in the USA and which application is incorporated herein by reference. A claim of priority is made.

### BACKGROUND

Food plots are often planted to increase the presence and activity of wildlife for hunting or observation. Hunters and landowners choose the type of seed for such supplemental seeding based on a number of factors including feeding for specific game, nutrition, speed of growth and ease of growth (i.e., low maintenance).

In addition to choosing a type of seed and ultimately the type of plant to use in a food plot, the location is also evaluated. Shielding the wildlife from human activity encourages the game to use the plot during convenient daylight hours and protects a hunter's investment by discouraging poaching. If an ideal location is not available on a given piece of land, an attempt to shield the plot using tall plants or trees is sometimes utilized. Planting and cultivating trees can take years and ultimately not provide enough cover. Using tall plants or corn is quicker, but in harsh climates, wind and snow can trample the shielding plants, rendering them useless.

### SUMMARY

Embodiments of the present invention describe a food plot screen seed mixture including one or more low height plant seeds, one or more medium height plant seeds and one or more tall height plant seeds.

### BRIEF DESCRIPTION OF DRAWINGS

FIG. 1 shows a block flow diagram of a method of screening a food plot, according to embodiments of the present invention.

### DETAILED DESCRIPTION

Embodiments of the present invention disclose a mixture or composition of mixed height plant seeds that grow to provide a screen for a food plot that can withstand harsh environmental effects, such as wind and heavy snow. By growing a low height plant, medium height plant and tall height plant (or more than one of each), not only does the screen provide better visibility protection, but the shorter plants support the taller plants, preventing the screen from falling over by blowing wind or weight of snow cover. By selectively choosing a mixed height plant seed mixture that includes two or more seed heights, a food plot screen is developed that provides visible protection from humans, encourages daylight use of the food plot by game and withstands harsh weather often found in the northern half of the United States and most of Canada, for example.

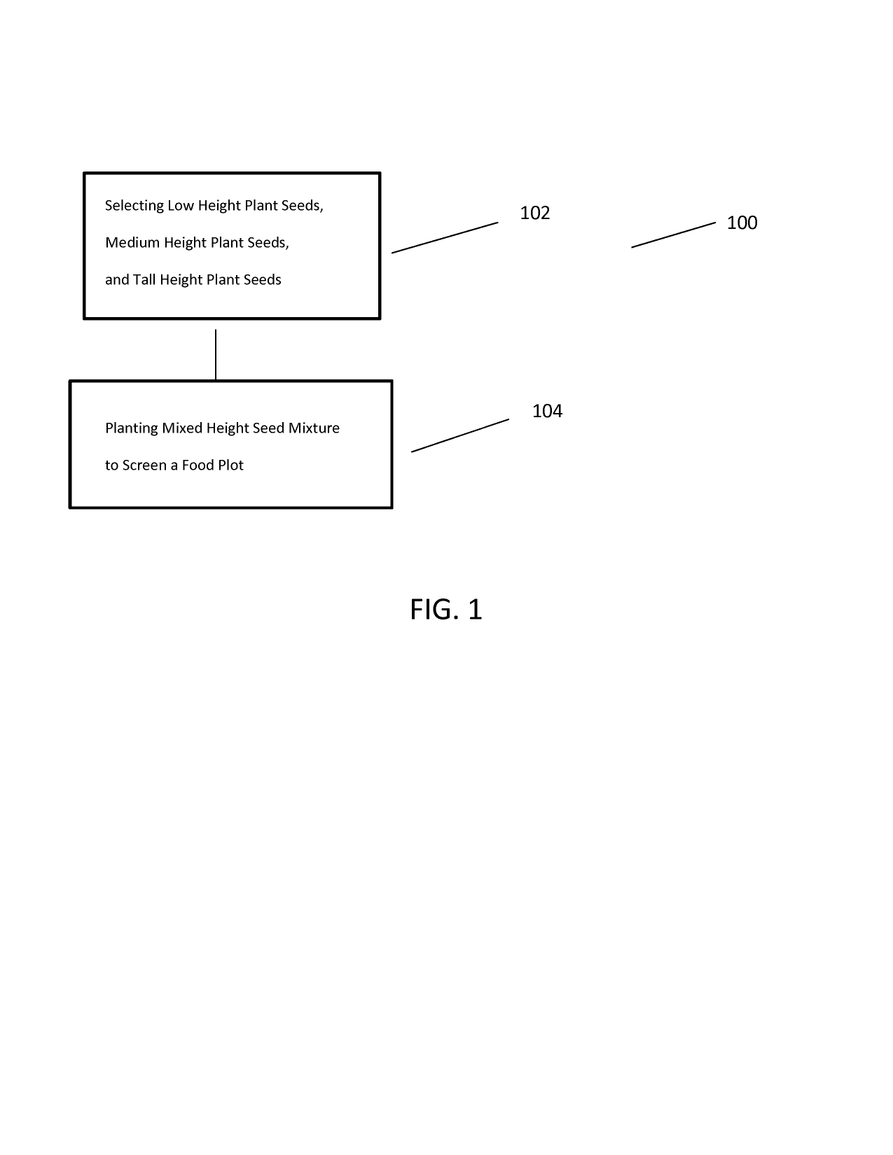

Referring to FIG. 1, a block flow diagram of a method 100 of screening a food plot is shown, according to embodiments of the present invention. One or more low height plant seeds, one or more medium height plant seeds and one or more tall height plant seeds are selected 102 and mixed to form a mixture. The mixture is planted 104 within or near a food plot. Once the seeds form mature plants, a food plot screen is formed.

One or more low height plant seeds are selected based on factors such as hardiness, durability and foliage capable of supporting the medium height and tall height plants. Medium height plant seeds are similarly selected for hardiness, durability and foliage, capable of supporting the tall height plants. Low height plant seeds are generally seeds that produce plants less than about 5 feet tall. An example of a low height plant seed includes grain sorghum. Medium height plant seeds are generally seeds that produce plants of a height from about 5 foot to about 8 foot tall. Examples of medium height plant seeds include sunflower, sorghum Sudan hybrid, Rox Orange Cane, native grasses and corn. Tall height plant seeds are generally seeds that produce plants of a height greater than about 8 feet tall. An example of tall height plant seeds are forage sorghum, sudangrass and Egyptian wheat (sorghum).

The amount of each type of seed by height can be adjusted based on environmental conditions, soil type, cost, ease of growth, amount of maintenance to cultivate, foliage thickness and propensity for game to prefer that type of plant. The size of seed is also considered when blending for planting with a seeder. The amount of tall height plant seed can be between about 25% to about 75% of the mixture by weight, about 35% to about 65% or about 45% to about 55% of the mixture by weight. The amount of medium height plant seed can be between about 25% to about 75% of the mixture by weight, about 15% to about 45% or about 20% to about 30% of the mixture by weight. The amount of low height plant seed can be between about 25% to about 75% of the mixture by weight, about 15% to about 45% or about 20% to about 30% of the mixture by weight. An example mixture is about 50% tall height plant seed, about 25% medium height plant seed and about 25% low height plant seed by weight.

Additional food source seeds can be added as well, such as millet, for example. One or more of each seed type can be annuals, perennials or a mix.

The seed mixture can be planted using machinery, drilling or broadcast for example. The food plot screen can be used to partition a food plot in sections, surround one or more sides of a food plot or planted within proximity or adjacent such that it screens or partially screens the food plot.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. All documents referred to herein are hereby incorporated by reference for any purpose. However, if any such document conflicts with the present application, the present application controls. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of screening a food plot, comprising:
planting a mixed height plant seed mixture in contact with or in proximity to a food plot.

2. The method of claim 1, comprising before planting, selecting one or more low height plant seeds, one or more medium height plant seeds and one or more tall height plant seeds.

3. The method of claim 2, after selecting, mixing the one or more low height plant seeds, one or more medium height plant seeds and one or more tall height plant seeds.

4. The method of claim 2, after selecting, mixing the one or more low height plant seeds, one or more medium height plant seeds and one or more tall height plant seeds.

5. The method of claim 2, further comprising selecting an additional food source seed, visibility protection seed or a combination thereof.

6. The method of claim 1, wherein the one or more low height plant seeds comprises grain sorghum.

7. The method of claim 1, wherein the one or more medium height plant seeds comprises sunflowers, sorghum Sudan hybrid or a combination thereof.

8. The method of claim 1, wherein the one or more tall height plant seeds comprises Egyptian wheat.

9. A food plot screen seed mixture, comprising:
one or more low height plant seeds;
one or more medium height plant seeds; and
one or more tall height plant seeds.

10. The mixture of claim 9, wherein the one or more low height plant seeds comprises grain sorghum.

11. The mixture of claim 9, wherein the one or more medium height plant seeds comprises sunflowers, sorghum Sudan hybrid or a combination thereof.

12. The mixture of claim 9, wherein the one or more tall height plant seeds comprises Egyptian wheat.

13. The mixture of claim 9, wherein the mixture comprises about 25% to about 75% one or more low height plant seeds, about 25% to about 75% one or more medium height plant seeds, and about 25% to about 75% one or more tall height plant seeds.
